(19) United States
(12) Patent Application Publication
(10) Pub. No.: US 2020/0062215 A1
(43) Pub. Date: Feb. 27, 2020

(54) METHOD FOR AUTHORIZING ACCESS TO A MOTOR VEHICLE FOR USE BY A THIRD PARTY, AND SYSTEM

(71) Applicant: AUDI AG, Ingolstadt (DE)

(72) Inventor: Florian SCHULLER, Ismaning (DE)

(73) Assignee: AUDI AG, Ingolstadt (DE)

(21) Appl. No.: 16/348,306

(22) PCT Filed: Sep. 15, 2017
(86) PCT No.: PCT/EP2017/073309

§ 371 Date: May 8, 2019

(30) Foreign Application Priority Data
Nov. 16, 2016 (DE) 10 2016 222 541.3

(51) Int. Cl. B60R 25/20; G07C 9/00; G06Q 50/30; G06Q 10/08; G05D 1/00

(52) U.S. Cl. CPC B60R 25/2018; G07C 9/00309; G06Q 50/30; B60R 2025/1016; G07C 9/00857; G05D 1/0011; B60R 2325/103; G06Q 10/083

(57) ABSTRACT

A method for authorizing access to a motor vehicle for use by a third party. In the method, first a request message requesting use by a third party is received by a server device. After the request message is received, an access code by which the third-party use is authorized is generated. A release message is then output to the third party, said release message containing the access code. In a further method step, a test code which matches the access code is output to the motor vehicle. Finally, access to the motor vehicle for the third-party use is authorized if the motor vehicle receives an access code via a near-field receiving device, said access code matching the test code which has been transmitted to the motor vehicle by the server device.

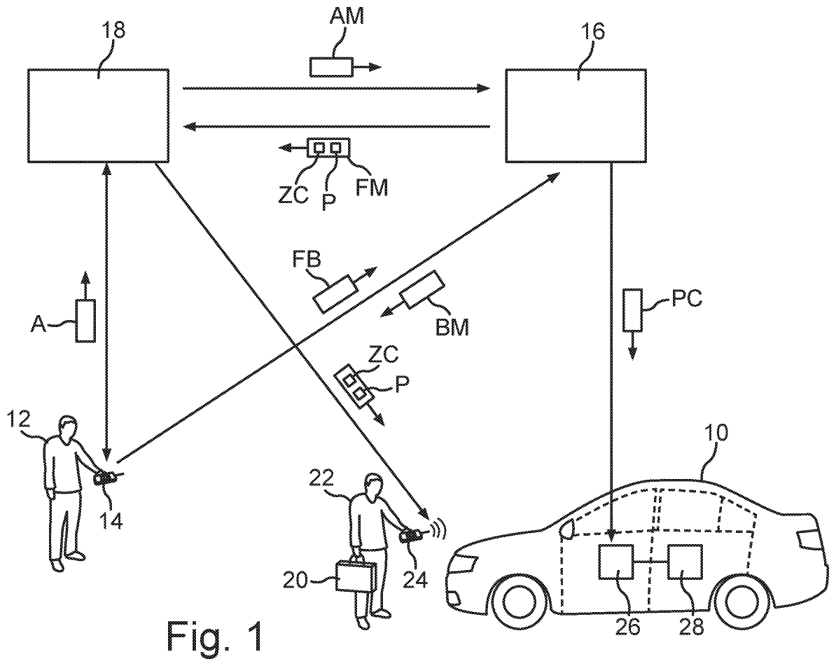

The invention relates to a method for authorizing access to a motor vehicle for use by a third party. The invention also relates to a system which can be operated by the method according to the invention.

It is already known per se that motor vehicles can be unlocked, locked and also started by means of a near-field communication device such as, for example, a smartphone, a smartcard, a smartwatch or the like as an alternative to conventional vehicle key.

From the general prior art, it is known that such motor vehicles have unauthorized access warning systems which monitor the interior of the motor vehicle or a vehicle position in which the motor vehicle has been parked. In addition, such systems have a sound generators in the motor vehicle, which output an acoustic signal in the case of an unauthorized access. Furthermore, from the general prior art, additional approaches which counteract unauthorized access to a motor vehicle are known.

Thus, for example, in DE 10 2007 005 150 B3, a computer arrangement for a motor vehicle is described, which comprises a main computer and a monitoring computer. At least one sensor and at least one actuator are here associated with the main computer. The monitoring computer is configured to regularly monitor a functionality of the main computer. The monitoring computer comprises a memory in which at least one security function and/or security data are programmed, which contribute to protecting the motor vehicle against unauthorized access. Such a computer arrangement has the disadvantage that its operation is particularly elaborate.

In DE 10 2013 214 018 A1, a system for a motor vehicle for the automated control of at least one safety-relevant function is described. For this purpose, the system comprises a mobile request device and an execution device. Here, the mobile request device comprises a request element, an authentication element and a transmission module. The execution device in turn comprises a receiving module and a control module. Here, the execution device is arranged in the vehicle. The request element is configured to provide, in response to a safety-relevant request of a user, corresponding request information to the transmission module. The authentication element is configured to provide authentication information to the transmission module. The transmission module is configured to transmit, when request information is provided by the request element, both the provided request information and also the provided authentication information as authenticated request information to the execution device. The receiving module is configured to receive the authenticated request information, to validate the authentication information contained in the authenticated request information, and, if the authentication information is valid, to forward the request information containing authenticated request information to the control module. The control module is configured to execute the request information in an automated manner Such a system is configured in a particularly complex manner.

An additional method which can limit access to a vehicle in the case of unauthorized access is described in DE 10 2014 221 772 A1. In the method described therein, in the case of a vehicle-external access to one or more vehicle components, the access is restricted or interrupted by means of a vehicle-internal security device if a corresponding request has been received by the vehicle via a communication network.

In addition to the complex configuration and the elaborate operation of such systems which indicate or restrict an unauthorized access, none of the systems provides a possibility for authorizing the third-party use of the corresponding motor vehicle.

Therefore, the aim of the present invention is to provide a method for authorizing access to a motor vehicle for third-party use, which can be operated particularly easily and nevertheless particularly reliably, in particular with regard to an unauthorized access to the motor vehicle.

This aim is achieved by a method for authorizing access to a motor vehicle for third-party use and by an associated system having the features of the independent claims. Advantageous designs with appropriate and nontrivial developments of the invention are indicated in the dependent claims.

In the method for authorizing access to a motor vehicle for use by a third party, a third-party request message requesting use be a third party is first received by a server device. “Third-party use” here is understood to mean in particular that the motor vehicle is used not by the owner himself/herself but rather by another person and in particular for a purpose other than for driving. The third party can be a service provider, for example. The service provider can then assign an executing person who is to carry out the third-party use. A server device of the service provider can be configured to output the request message. Alternatively, the third party can also be a person who carries out the third-party use.

After the request message is received, an access code is generated, by means of which the third-party use is authorized. Subsequently, a release message is output to the third party, wherein the release message contains the access code. In other words, in response to the request message, the access code is assigned to the third party so that said third party is authorized to carry out the third-party use with the help of the assigned access code.

So that the third party can be authorized to access the motor vehicle, a test code matching the access code is output to the motor vehicle in an additional method step. The access code and the test code preferably consist of a digital key, wherein the access code is assigned to the third party and the test code is assigned to the motor vehicle. The generation of the access code and of the test code can occur based on a symmetric encryption or an asymmetric encryption. In the asymmetric encryption, a pair of keys—a public key and a private key—is generated. In symmetric encryption, in contrast to asymmetric encryption, the two participants use the same key. As a key in symmetric encryption, a PIN code or a password can be issued, for example.

Finally, if the access to the motor vehicle for use by the third party is authorized, then the motor vehicle receives, via a near-field receiving device, an access code which matches the test code transmitted to the motor vehicle by the server device. In other words, access to the motor vehicle is authorized if the motor vehicle receives the access code matching the test code via the near-field receiving device. Here, the authorization is preferably provided only or exclusively for the scope of the third-party use. Preferably, an authorized access to the motor vehicle occurs only when the motor vehicle is at a stop or in a parked state. In other words, the motor vehicle is not moving during the authorized access.

By the method for authorizing access to the motor vehicle for use by a third party, the third party is granted access to the motor vehicle under concrete conditions indicated in the request. Via the request message, the access code is generated, and the motor vehicle is prepared for authorized access, in that the test code is transmitted to the motor vehicle. Thereby, an access to the motor vehicle is granted to the third party in a particularly simple manner By the generation of the access code and of the test code, the method for authorizing access is configured particularly securely and reliably.

An embodiment provides that the access code and/or test code is/are temporally limited. In other words, the validity of the access code and/or the test code can be temporally limited. For example, it can be provided that the server device is configured to authorize the access code only for a predetermined time window when the access code is established.

Correspondingly, when the release message is output, the server device can be configured to communicate to the third party the access code by means of the release message and the time window assigned to the access code. By the temporal restriction of the access code and/or of the test code, it can be ensured that the vehicle can be accessed only within a predetermined time window. Thereby, security can be increased when access to the vehicle is authorized.

An advantageous development of the invention provides that, after the request message is received, a position of the motor vehicle is determined or ascertained, and, when the release message is output, the release message also contains the position of the motor vehicle. The position determination of the motor vehicle can preferably occur by a GPS system. Alternatively or additionally, it can be provided that in regions in which no GPS reception is possible, that is to say in GPS-shaded regions, the position determination of the vehicle occurs by map-assisted or map-based methods and/or sensors of the motor vehicle. For example, a camera as sensor of the motor vehicle, which is aimed at the surroundings of the motor vehicle, can acquire image data. By the evaluation of the image data, for example, by comparison of the image data with image data stored by the motor vehicle or the server device, it is possible to determine the current position of the motor vehicle. Via the position of the motor vehicle, the third party knows precisely in which position the motor vehicle is located, where the third-party use is to occur. This simplifies the locating of the motor vehicle for the third party.

Furthermore, via the position of the motor vehicle, it is possible to prevent access to the wrong motor vehicle.

Advantageously, the motor vehicle is operated in an autonomous or fully automated driving mode. Autonomous driving mode here preferably is understood to mean that the vehicle moves autonomously. In autonomous driving mode it can be provided that no one is in the motor vehicle or that there is no active vehicle driver or only passengers are in the motor vehicle. For example, the motor vehicle is configured to drive in autonomous driving mode autonomously from a delivery location to a predetermined position. For example, the motor vehicle can drive autonomously from a parking place at the delivery location to a parking position, in particular park there. Additionally or alternatively, it can be provided that the motor vehicle is configured to drive from the predetermined position back to the delivery location. “Delivery location” here preferably is a position in which a driver of the motor vehicle has parked the vehicle or has gotten out of the motor vehicle. In autonomous driving mode, the driver of the motor vehicle therefore no longer has to deal with further operation of the motor vehicle.

Alternatively or additionally, it can be provided that the autonomous driving mode of the motor vehicle is interrupted during the third-party use. In addition, it is possible to provide that the autonomous driving mode of the motor vehicle is continued when the third-party use has ended.

An advantageous development provides that the third-party use comprises delivery of a product and/or service. For example, a deadline or date of delivery of a product, for example, of a parcel, by the third party can be stored in the server device. Thus, for the third party to be able to deliver the product to the vehicle on the deadline or date, the third party transmits a request message to the server device. In this case, the third party can be, for example, a parcel supplier. In response to the request message, the server device transmits the access code and the position of the motor vehicle to the parcel supplier, in particular to the server device of the parcel supplier. The parcel supplier can transmit the access code and the position of the motor vehicle to a mail carrier of the parcel supplier, in particular to a reader of the mail carrier who is to deliver the product. If the mail carrier brings the product to the motor vehicle, then the reader of the mail carrier can detect the near-field receiving device which transmits the access code to the motor vehicle. A control device of the motor vehicle can compare the access code with the test code after receiving the access code. If the test code and the access code match or the two codes correspond to one another, then the access to the motor vehicle is authorized. For example, the mail carrier can then open a door of the motor vehicle and deposit the product in the motor vehicle. Additionally or alternatively, after the delivery of the product, the mail carrier can transmit a delivery message to the parcel supplier, which confirms the completion of the delivery of the parcel. The parcel supplier can forward the delivery message to the server device. Alternatively or additionally, the third-party use can also comprise a service such as, for example, servicing of the motor vehicle and/or inspecting the motor vehicle and/or cleaning of the motor vehicle.

An additional advantageous embodiment provides that, in the case of authorization of access to the motor vehicle, at least one door and/or trunk lid and/or engine hood of the motor vehicle is released. In particular, the release is limited thereto. Access here is understood to mean in particular that access to the motor vehicle via one or more doors of the motor vehicle is provided and/or an engine hood and/or a trunk lid is opened. For example, if a product is delivered to the motor vehicle, then a door or the trunk lid can be released, so that the mail carrier can deposit the product on a seat of the motor vehicle or in the trunk space of the motor vehicle. For example, if, as third-party use, an inspection is to be carried out, then only the engine hood can be released, for example.

Advantageously, the release message is output only after a release confirmation from a registered user is received. The registered user can be the driver of the motor vehicle, for example. In the sense of the invention, a registered user is understood to be a user whose name and contact data such as, for example, a mobile phone number, are stored in the server device. For example, it can be provided that upon receiving of the release message the server device transmits a confirmation message to a portable mobile terminal of the registered user. The portable mobile terminal can be, for example, a smartphone or a tablet computer. The confirmation message can display the third-party use request to the user. For example, if a product is to be delivered to the motor vehicle, a type of product delivery such as, for example, a parcel delivery, and/or a date or deadline and/or the name of the service provider, such as, for example, the name of the parcel supplier, can be displayed on the smartphone for the user. By means of the confirmation message, the registered user can be provided with information on who wishes to access the motor vehicle and/or how the motor vehicle is to be accessed and/or when the motor vehicle is to be accessed. If the registered user approves the third-party use, then he can issue a release confirmation after the confirmation message is received. Subsequently, the server device can output the release message to the third party. Via the release confirmation, the security of the method for authorizing access to the motor vehicle for third-party use can be increased.

Advantageously, it is provided that, when the near-field device detects that an unauthorized access to the motor vehicle occurs, a message is output, in particular to the registered user. Preferably, the registered user can be informed about an unauthorized access to his motor vehicle. An unauthorized access to the motor vehicle exists, for example, when access to the motor vehicle occurs without reception of the access code via the near-field receiving device.

Additionally or alternatively, it can be provided that a detection device of the motor vehicle is configured to detect the type of access in the case of an authorized and/or unauthorized access to the motor vehicle. The detection device can comprise, for example, a camera which is pointed to surroundings of the motor vehicle, and/or it can comprise a proximity sensor and/or capacitive sensors on door handles of the motor vehicle. For example, if an unauthorized access to the motor vehicle occurs, then the type of access such as, for example, the opening of a driver door of the motor vehicle, can be detected by the detection device. A control device of the motor vehicle can then be configured to output a message to the user, which communicates the type of the access and/or the time of the unauthorized access. Via the communication of the access to the motor vehicle, the user is informed about the access to his motor vehicle.

Additionally or alternatively, it can be provided that the detected accesses to the motor vehicle are stored in a memory of the motor vehicle or are transmitted to the server device. When the user of the motor vehicle then returns to his motor vehicle or when he checks via an Internet connection, he can either be informed by the motor vehicle or by the server device about the accesses to the motor vehicle. For example, the access attempts can be transmitted to the portable mobile terminal of the user, or the access attempts can be displayed for the user on a display device in the motor vehicle. Via the detection of the type of access to the motor vehicle, for example, by a sensor system, and the documentation of the accesses, a targeted evaluation of the type of access can be made and the user can be concretely informed about events at the motor vehicle.

Advantageously, it is provided that, when the near-field receiving device detects that an unauthorized access to the motor vehicle occurs, the autonomous driving mode is interrupted. If the autonomous driving mode is interrupted, no access authorization can be carried out. Preferably, the vehicle is then at a stop and/or in a barred or locked state. Thereby, it can be ensured that no one else can gain access to the vehicle except for the driver—the registered user.

The invention also includes a system which comprises a server device and a motor vehicle with a near-field receiving device. The server device can be configured to receive a third party request message requesting a use by a third party. Furthermore, the server device is configured to generate, after receiving the request message, an access code which authorizes the use by the third party and to output a release message to the third party, said release message containing the access code. The motor vehicle is configured to receive a test code which matches the access code and to authorize the access to the motor vehicle for use by a third party if the motor vehicle receives, via a near-field receiving device, an access code matching the test code which has been transmitted to the motor vehicle by the server device.

According to a preferred embodiment, it is provided that the near-field receiving device comprises an NFC device. Near-field communication, abbreviated NFC, is an international transmission standard based on the RFID technology for contactless exchange of data per radio technology over short distances of a few centimeters.

The advantages and preferred embodiments described for the method according to the invention also apply to the system according to the invention.

Below, an embodiment example of the invention is described. For this purpose, the single FIGURE (FIG.) shows, in a diagrammatic representation, an authorization process for third-party use of the motor vehicle 10. The motor vehicle 10 preferably is a car, in particular a passenger car.

The embodiment example explained below is a preferred embodiment of the invention. In the embodiment example, the described components of the embodiment in each case represent individual features of the invention, considered independently of one another, which in each case also develop the invention independently of one another and therefore should also be considered, individually or in a combination other than the combination shown, to be part of the invention. Moreover, others of the already described features of the invention can also be added to the described embodiment.

The motor vehicle 10 is located, for example, in a parking place in a parking garage. Furthermore, the motor vehicle 10 is operated in an autonomous or fully automatic driving mode. The motor vehicle 10 was parked by a driver or user 12 of the motor vehicle 10 at a delivery location. At the delivery location, the user 12 got out of the motor vehicle 10. The motor vehicle 10 was transferred by the user 12 at the delivery location in the autonomous driving mode. The motor vehicle 10 is configured to drive then from the delivery location to a predetermined position. For example, the motor vehicle 10 was parked by the user 12 at the delivery location in a parking garage. In the autonomous driving mode, the motor vehicle 10 subsequently drives automatically from the delivery location to a parking position and parks there. In order for the motor vehicle 10 to be able to move automatically from a delivery location to a predetermined position, the motor vehicle 10 communicates, for example, via a radio connection with a local infrastructure. The local infrastructure is configured to coordinate the functional sequences of the motor vehicle 10, that is to say the movement of the motor vehicle from the delivery location to the predetermined position.

In the embodiment example, the motor vehicle 10 is located in the parking garage. In order for the motor vehicle 10 to be able to drive to the parking position automatically, the motor vehicle 10 communicates via a radio connection with a communication network of the parking garage.

In addition, the motor vehicle 10 communicates with a portable mobile terminal 14 of the user 12. This allows the user 12 to be apprised of the functional sequences of the motor vehicle 10 via the portable mobile terminal 14. For example, the motor vehicle 10 can communicate with the portable mobile terminal 14 via an Internet connection. For example, the motor vehicle 10 can communicate directly or via a server device 16 with the portable mobile terminal 14. The portable mobile terminal 14 is, for example, a smartphone or a tablet computer.

If the motor vehicle 10 is not being used by the user 12, then the motor vehicle 10 can be authorized for use by a third party. For example, during the absence of the user 12, as third-party use, a product can be delivered to the motor vehicle 10 and/or a service can be carried out on the motor vehicle 10. As service performance, for example, a cleaning and/or an inspection and/or a tire change can be carried out on or in the motor vehicle 10.

So that the third-party use can be carried out on the motor vehicle 10, first an authorization of access to the motor vehicle 10 for the third-party use must occur. For this purpose, a third party 18 transmits a request message AM to the server device 16. After receiving the request message AM, the server device 16 is configured to generate an access code ZC which authorizes the third-party use. The access code ZC is preferably a key. After the generation of the access key ZC, the server device 16 transmits a release message FM which contains the access code ZC to the third party 18.

A third-party use can consist, for example of the delivery of a parcel 20 as product. Accordingly, the third party 18 can be a parcel supplier. A server device of the parcel supplier can transmit the request message to the server device 16. After the release message FM is received, the parcel supplier, in particular the server device of the parcel supplier, can transmit the access code ZC to a person 22 executing the third-party use. For example, the person 22 executing the third-party use can be a mail carrier who delivers the parcel 20. The access code ZC can then be transmitted to a near-field communication device 24 such as, for example, a reading device or a smartphone. The near-field communication device 24 is carried by the person 22 executing the third-party use. For example, the person 22 executing the third-party use is a mail carrier.

In order for the third party 18 to be allowed access to the motor vehicle 10, the server device 16 outputs a test code PC matching the access code to the motor vehicle 10. The test code PC, just like the access code ZC, can be transmitted in a message. The test code PC can be stored, for example, in a memory of a control device 26 of the motor vehicle 10.

When the person 22 executing the third-party use approaches the motor vehicle 10 for the third-party use of the motor vehicle 10, then the near-field communication device 24 can transmit the access code ZC to the motor vehicle 10. A near-field receiving device 28 receives or detects the access code ZC. Subsequently, the access code ZC is verified in the motor vehicle 10. For this purpose, the near-field receiving device 28 can transmit the access code ZC to the control device 26. The control device 26 can be configured to compare the access code ZC and the test code PC or to verify the access code ZC and the test code PC. If the received access code ZC is a code associated with the test code PC, then the access is authorized. During the authorization of the access to the motor vehicle 10, one door or several doors and/or a trunk lid of the motor vehicle 10 can be released. For example, due to the authorization of the person 22, the trunk lid of the motor vehicle 10 can be opened in order to be able to place the parcel 20 in the trunk space of the motor vehicle 10.

Alternatively it can be provided that the reading device is designed as a barcode device and the near-field receiving device 28 is configured to display a barcode as test code PC. For example, the near-field receiving device 28 can comprise a display with the barcode inserted.

When the mail carrier scans the barcode with the reading device, the access can thus be authorized.

In addition, after the delivery of the parcel 20, the person 22 can transmit a delivery message to the parcel supplier, which confirms the completed delivery of the parcel 20. The parcel supplier can forward the delivery message to the server device 16. The server device 16 in turn can then inform the user 12 about the completed delivery.

In order to provide support for the mail carrier or in general for the person 22 executing the third-party use in the delivery of the parcel 20 or in finding the motor vehicle 10, it can be provided that a current position of the motor vehicle 10 is detected. For example, the position of the motor vehicle 10 can be determined by a GPS system. For example, the current position of the motor vehicle 10 can be determined continuously. Alternatively, it can be provided that the motor vehicle 10 transmits the predetermined position to the server device 16 as soon as it has reached the predetermined position.

If the server device 16 transmits the release message FM to the third party 18, then the release message FM can contain not only the access code ZC, but also the current position P of the motor vehicle 10. In the case of the parcel supplier, the server device of the parcel supplier can then transmit the access code ZC and the GeoPosition GP to the near-field communication device 24. The position of the motor vehicle 10, where the mail carrier has to deliver the parcel 20, can then be displayed for the mail carrier on a screen of the near-field communication device 24.

For an assignment of the third party 18 to occur in the first place, the user 12 can output an order message A to the third party 18. In the case of the parcel supplier as third party 18, the user 12 can issue an order for a product as order message A. For example, the third party 18 can then communicate an order number to the user. At the same time, the user 12 can also output such an order message to the server device 16, so that the server device 16 stores the assignment of a third party 18. For example, the order message can comprise a product type and/or a name of the user 12 and/or the order number and/or a mobile radio number of the smartphone of the user 12—that is to say of the portable mobile terminal of the user 12. When the request message AM is received, the server device 16 can then be configured to compare the request message AM with the order message A. For example, a control device of the server device 16 can be configured to compare the order number of the request message and of the order message A. If the two numbers match, the server device 16 can output the release message FM.

In order to ensure that the user 12 approves the third-party use of the motor vehicle 10, it is possible to provide, in addition, that the release message FM is output only after a release confirmation FB has been received by the registered user 12.

Moreover, it can be provided that, when the request message AM is received, the server device 16 transmits a confirmation message BM to the portable mobile terminal 14 of the registered user 12. The confirmation message BM can display the request for use by the third party 18 to the user 12. For example, if the parcel 20 is to be delivered to the motor vehicle 10, a product delivery type, such as, for example, parcel delivery, and/or a date or deadline and/or the name of the parcel supplier can be displayed on the smartphone for the user 12. After reception of the confirmation message BM, the user 12 can decide whether or not he releases the third-party use. If the user 12 confirms the third-party use, that is to say, for example, the delivery of the parcel 20 to the motor vehicle 10, then he transmits a release confirmation FB to the server device 16.

While the motor vehicle 10 is in the autonomous mode, it can happen that an unauthorized access to the motor vehicle 10 occurs. For example, a detection device of the motor vehicle 10 can detect the occurrence of an approach to the motor vehicle 10. The detection device can comprise, for example, a proximity sensor and/or a camera. If, in the case of a detected approach to the motor vehicle, no access code ZC is detected by the near-field receiving device 28, then an unauthorized access to the motor vehicle 10 is occurring. Subsequently, the control device 26 of the motor vehicle 10 can communicate an unauthorized access to the motor vehicle 10 to the server device 16. The server device 16 can be configured to inform the user 12. For example, the server device 16 can output a warning message to the smartphone—the portable mobile terminal. The detection device of the motor vehicle 10 can moreover be configured to detect the type of the access. For example, the detection device can be configured to detect the door of the motor vehicle 10 where an unauthorized access is occurring. Accordingly, the warning message can also comprise the type of the access to the motor vehicle 10.

Overall, the invention describes a use of information about attempts to access a motor vehicle, in particular in a fully automatic driving mode or piloted mode of the motor vehicle. In the process, attempts to access the motor vehicle are detected and evaluated, in particular in the piloted mode of the motor vehicle.

The detection of access attempts can occur by a sensor system of the motor vehicle. Furthermore, an evaluation of the access type can be carried out in a targeted manner (for example, passenger space, trunk space, etc.) by the sensor system.

According to a particularly preferred embodiment, an evaluation of access attempts occurs by the piloted function and an inclusion in the performance of functional sequences occurs.

The piloted motor vehicle is connected via radio connection to a local infrastructure which coordinates its functional sequences. Via an Internet connection, the motor vehicle is moreover connected to a portable mobile terminal of the user or customer or to a server device such as, for example, a web service.

While the motor vehicle is in the piloted mode, access attempts are continuously monitored via a sensor system on vehicle doors and/or vehicle handles and via sensors for the interior. The identification of the access authorization occurs via evaluation of information of a mobile device of the corresponding person who wants to access the motor vehicle. If an identification is not possible or fails, the access attempt is evaluated as unauthorized.

The piloted function evaluates the access attempts and uses the information by comparing with data concerning booked services such as, for example, the delivery of a product. In the case of an unauthorized access attempt, the piloted function is deactivated for security reasons and the corresponding verification support, such as, for example, the server device, is requested via the connection with the infrastructure.

Alternatively or additionally, it can be provided that the piloted function of the motor vehicle is interrupted during the third-party use. In addition, it is possible to provide that the piloted function of the motor vehicle is continued when the third-party use is terminated. In particular, the piloted function or the piloted driving process can be continued after a successful delivery of the product. For example, the third-party use is terminated when the mail carrier has delivered the parcel.

The motor vehicle transmits all the access attempts to a mobile terminal of the user and/or stores the data in a portal accessible to the user, such as, for example, a server device in the Internet, for subsequent viewing.

During the activated piloted function of the motor vehicle, access attempts can thus be transmitted live to the user. Here, by filtering the data, a selective choice can also be made (for example, an unauthorized access warning).

1-10. (canceled)

11. A method for authorizing access to a motor vehicle for use by a third party, comprising the steps:
receiving, by a server device, of a third party request message (AM) requesting use by the third party;
generating an access code (ZC) after the request message (AM) is received by which the third-party use is authorized;
outputting of a release message (FM) to the third party, said release message containing the access code (ZC);
outputting of a test code (PC) which matches the access code (ZC) to the motor vehicle;
authorizing of the access to the motor vehicle for the third-party use if the motor vehicle receives an access code (ZC) via a near-field receiving device, said access code matching the test code (PC) which has been transmitted to the motor vehicle by the server device.

12. The method according to claim 11, wherein after the request message (AM) is received, a position (P) of the motor vehicle is determined, and, when the release message (FM) is output, the release message (FM) also contains the position (P) of the motor vehicle.

13. The method according to claim 11, wherein the motor vehicle is operated in autonomous driving mode.

14. The method according to claim 13, wherein if the near-field receiving device detects that an unauthorized access to the motor vehicle occurs, the autonomous driving mode of the motor vehicle is interrupted.

15. The method according to claim 11, wherein the release message (FM) is output only after a release confirmation (FB) from a registered user is received.

16. The method according to claim 11, wherein if the near-field receiving device detects that an unauthorized access to the motor vehicle occurs, a message is output.

17. The method according to claim 11, wherein the use by the third party comprises a delivery of a product and/or a service.

18. The method according to claim 11, wherein when access to the motor vehicle is authorized, at least a door and/or a trunk lid and/or an engine hood of the motor vehicle is released.

19. A system comprising:
a server device, wherein the server device is configured to receive a third party request message (AM) requesting use by a third party, wherein
the server device is moreover configured to generate, after the request message (AM) is received, an access code (ZC) by which the use by the third party is authorized, and to output a release message (FM) to the third party, said release message containing the access code (ZC);
a motor vehicle which is configured to receive a test code (PC) which matches the access code (ZC) and to authorize the access to the motor vehicle for the third-party use if the motor vehicle receives an access code (ZC) via a near-field receiving device, said access code matching the test code (PC) which has been transmitted to the motor vehicle by the server device.

20. The system according to claim 19, wherein the near-field receiving device further comprises an NFC device.

21. The method according to claim 12, wherein the motor vehicle is operated in autonomous driving mode.

22. The method according to claim 12, wherein the release message (FM) is output only after a release confirmation (FB) from a registered user is received.

23. The method according to claim 13, wherein the release message (FM) is output only after a release confirmation (FB) from a registered user is received.

24. The method according to claim 14, wherein the release message (FM) is output only after a release confirmation (FB) from a registered user is received.

25. The method according to claim 12, wherein if the near-field receiving device detects that an unauthorized access to the motor vehicle occurs, a message is output.

26. The method according to claim 13, wherein if the near-field receiving device detects that an unauthorized access to the motor vehicle occurs, a message is output.

27. The method according to claim 14, wherein if the near-field receiving device detects that an unauthorized access to the motor vehicle occurs, a message is output.

28. The method according to claim 15, wherein if the near-field receiving device detects that an unauthorized access to the motor vehicle occurs, a message is output.

29. The method according to claim 12, wherein the use by the third party comprises a delivery of a product and/or a service.

30. The method according to claim 13, wherein the use by the third party comprises a delivery of a product and/or a service.
